(19) United States
(12) Patent Application Publication
(10) Pub. No.: US 2016/0202669 A1
(43) Pub. Date: Jul. 14, 2016

(54) APPARATUS FOR REFRIGERATOR

(71) Applicant: Jamie McTaggart BONE, Ucluelet (CA)

(72) Inventor: Jamie McTaggart BONE, Ucluelet (CA)

(21) Appl. No.: 14/593,275

(22) Filed: Jan. 9, 2015

(51) Int. Cl. G05B 11/01; E05F 15/60; F25D 23/02

(52) U.S. Cl. CPC G05B 11/01; F25D 23/028; E05F 15/60; F25D 2600/00

(57) ABSTRACT

Apparatus is for refrigerator having refrigerator door. Refrigerator is configured to be electrically powered via an electrical power outlet. Apparatus includes power-control assembly is configured to: receive power-disconnect command signal indicating that electrical power is to be disconnected from refrigerator for case where power-disconnect command signal is received; disconnect electrical power to refrigerator for case where power-control assembly receives power-disconnect command signal; convey door-open signal indicating to open the refrigerator door for case where power-control assembly receives power-disconnect command signal. Actuator assembly configured to: receive door-open signal from power-control assembly once door-open signal is transmitted; and mechanically operate the refrigerator door for case where door-open signal is received from power-control assembly in such way that actuator assembly, in use, holds the refrigerator door, in use, ajar in door-open state.

### TECHNICAL FIELD

Some aspects generally relate to (and are not limited to) an apparatus for a refrigerator having a refrigerator door, and the refrigerator configured to be electrically powered via an electrical power outlet, and method therefor.

### BACKGROUND

A refrigerator is an appliance that includes a thermally insulated compartment and a heat pump configured to transfer heat from the inside of the refrigerator to an external environment so that the inside of the refrigerator may be cooled to a temperature below the ambient temperature of the room.

### SUMMARY

It will be appreciated there exists a need to mitigate (at least in part) at least one problem associated with existing refrigerators. After much study of the known systems and methods with experimentation, an understanding of the problem and its solution has been identified and is articulated as follows:

Most hotel motels and guest accommodations provide a bar refrigerator. The refrigerator is the highest consumer of electricity out of the range of home appliances. The bar refrigerator is the least efficient. It is believed that most overnight guests do not utilize the refrigerator (located in their rooms in a hotel and the like).

What is needed is an apparatus that can reduce the cost of operating the refrigerator (especially for hotels and the like). In this manner, the profitability of the hotel (and the like) may be improved once the apparatus is deployed.

To mitigate, at least in part, at least one problem associated with existing refrigerators, there is provided (in accordance with a major aspect) an apparatus. The apparatus is for a refrigerator having a refrigerator door. The refrigerator is configured to be electrically powered via an electrical power outlet. The apparatus includes a combination of a power-control assembly and an actuator assembly. The power-control assembly is configured to electrically connect to the electrical power outlet in such a way that electrical power is received from the electrical power outlet to the power-control assembly. The power-control assembly is also configured to electrically connect to an electrical cord of the refrigerator. The power-control assembly is also configured to provide the electrical power received from the electrical power outlet to the refrigerator via the power-control assembly. The power-control assembly is also configured to receive a power-disconnect command signal indicating that the electrical power is to be disconnected from the refrigerator for the case where the power-disconnect command signal is received by the power-control assembly. The power-control assembly is also configured to disconnect the electrical power to the refrigerator for the case where the power-control assembly receives the power-disconnect command signal. The power-control assembly is also configured to convey a door-open signal indicating to open the refrigerator door of the refrigerator for the case where the power-control assembly receives the power-disconnect command signal. The actuator assembly is configured to electrically couple to the power-control assembly in such a way that the actuator assembly receives the door-open signal from the power-control assembly once the door-open signal is transmitted from the power-control assembly. The actuator assembly is also configured to mechanically operate the refrigerator door for the case where the door-open signal is received from the power-control assembly in such a way that the actuator assembly, in use, holds the refrigerator door, in use, ajar in a door-open state.

To mitigate, at least in part, at least one problem associated with existing refrigerators, there is provided (in accordance with a major aspect) a method. The method is for operating a refrigerator having a refrigerator door. The refrigerator is configured to be electrically powered via an electrical power outlet by using an apparatus having a power-control assembly and an actuator assembly. The method includes configuring the power-control assembly to: (A) electrically connect to the electrical power outlet in such a way that electrical power is received from the electrical power outlet to the power-control assembly; (B) electrically connect to an electrical cord of the refrigerator; (C) provide the electrical power received from the electrical power outlet to the refrigerator via the power-control assembly; (D) receive a power-disconnect command signal indicating that the electrical power is to be disconnected from the refrigerator for the case where the power-disconnect command signal is received by the power-control assembly; (E) disconnect the electrical power to the refrigerator for the case where the power-control assembly receives the power-disconnect command signal; and (F) convey a door-open signal indicating to open the refrigerator door of the refrigerator for the case where the power-control assembly receives the power-disconnect command signal. The method also includes configuring the actuator assembly to: (A) electrically couple to the power-control assembly in such a way that the actuator assembly receives the door-open signal from the power-control assembly once the door-open signal is transmitted from the power-control assembly; (B) mechanically operate the refrigerator door for the case where the door-open signal is received from the power-control assembly in such a way that the actuator assembly, in use, holds the refrigerator door, in use, ajar in a door-open state.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 (SHEET 1 OF 2 SHEETS) depicts a schematic representation of an embodiment of an apparatus for a refrigerator configured to be electrically powered via an electrical power outlet; and

FIGS. 2A and 2B (SHEET 2 OF 2 SHEETS) depict schematic representations of embodiments of the apparatus of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 power-control assembly
104 actuator assembly
106 sensor assembly
900 refrigerator
902 refrigerator door
904 electrical power outlet

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

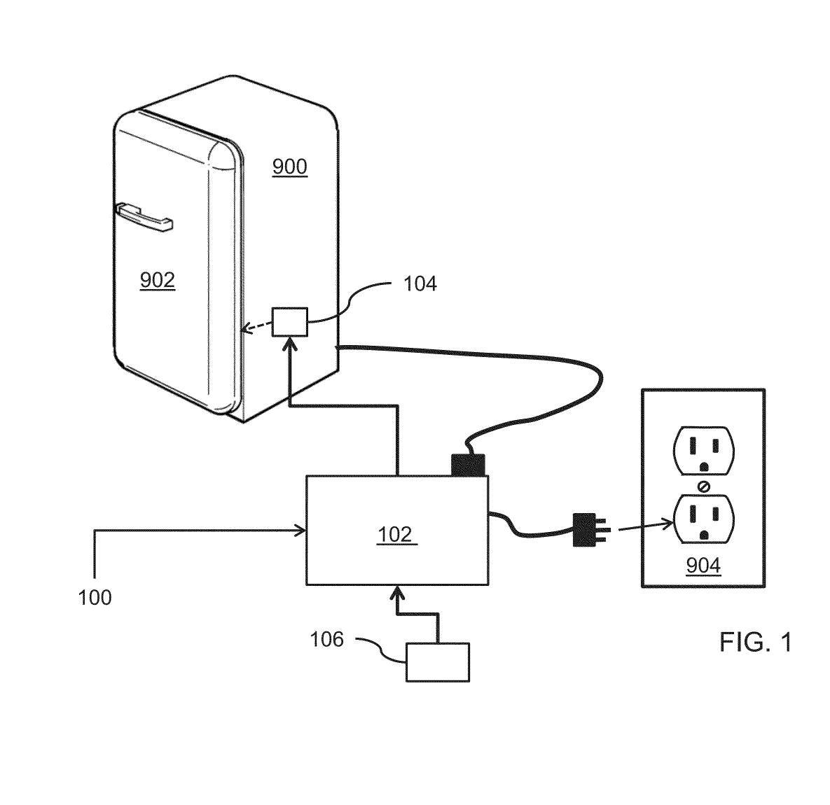

FIG. 1 depicts a schematic representation of an embodiment of an apparatus 100 for a refrigerator 900 configured to be electrically powered via an electrical power outlet 904.

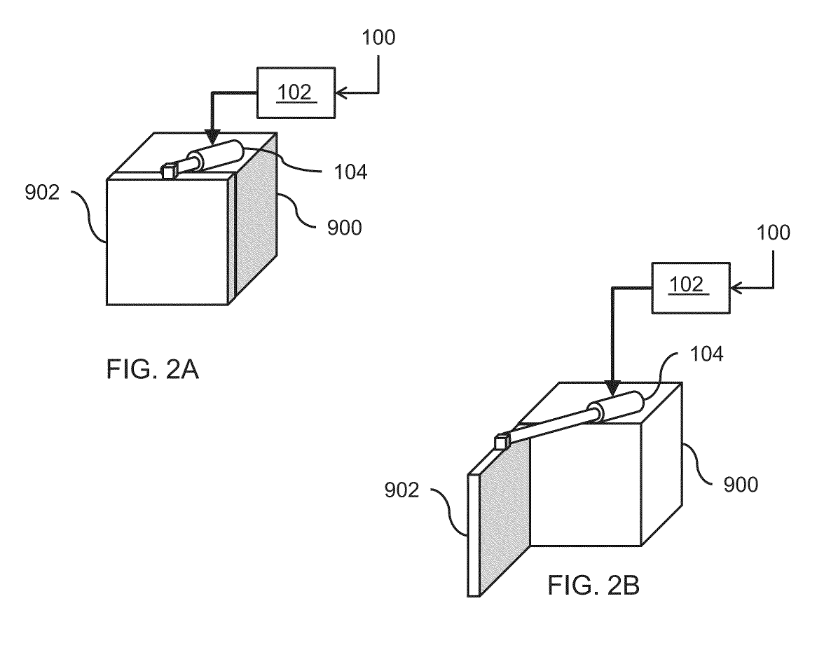

FIGS. 2A and 2B depict schematic representations of embodiments of the apparatus 100 of FIG. 1.

In accordance with FIGS. 1, 2A and 2B, the apparatus 100 is for the refrigerator 900. The refrigerator 900 has a refrigerator door 902. The refrigerator 900 is configured to be electrically powered via an electrical power outlet 904.

In accordance with an embodiment, the apparatus 100 includes a combination of a power-control assembly 102 and an actuator assembly 104.

The power-control assembly 102 is configured to electrically connect to the electrical power outlet 904. This is done in such a way that electrical power is received from the electrical power outlet 904 to the power-control assembly 102.

The power-control assembly 102 is also configured to electrically connect to an electrical cord of the refrigerator 900.

The power-control assembly 102 is also configured to provide the electrical power received from the electrical power outlet 904 to the refrigerator 900 via the power-control assembly 102.

The power-control assembly 102 is also configured to receive a power-disconnect command signal indicating that the electrical power is to be disconnected from the refrigerator 900 (such as, to be received from a sensor assembly 106) for the case where the power-disconnect command signal is received by the power-control assembly 102. The power-disconnect command signal may be received, in accordance with an option, from a sensor assembly 106.

The power-control assembly 102 is also configured to disconnect the electrical power to the refrigerator 900 for the case where the power-control assembly 102 receives the power-disconnect command signal.

The power-control assembly 102 is also configured to convey (transmit) a door-open signal indicating to open the refrigerator door 902 of the refrigerator 900 for the case where the power-control assembly 102 receives the power-disconnect command signal.

The actuator assembly 104 is configured to electrically couple (wirelessly or wired) to the power-control assembly 102 in such a way that the actuator assembly 104 receives the door-open signal from the power-control assembly 102 once the door-open signal is transmitted from the power-control assembly 102.

The actuator assembly 104 is also configured to mechanically operate the refrigerator door 902 for the case where the door-open signal is received from the power-control assembly 102 in such a way that the actuator assembly 104 holds the refrigerator door 902 ajar in a door-open state (as depicted in FIG. 2B).

The technical effect of the apparatus 100 (once the door-open state is achieved) is a reduction, at least in part, of the electrical energy consumed by the refrigerator 900 once the apparatus 100 shuts off electrical power to the refrigerator 900 (for the case where the hotel room, for example, remains empty or becomes unoccupied).

It will be appreciated that the power-disconnect command signal may be provided by a switch assembly and/or by a transmitter assembly. The switch assembly and/or the transmitter assembly may be included in a front lobby office of a hotel (for example).

The power-control assembly 102 is also configured to receive a power-connect command signal indicating that the electrical power is to be connected to the refrigerator 900 for the case where the power-connect command signal is received by the power-control assembly 102.

The power-control assembly 102 is also configured to connect the electrical power to the refrigerator 900 for the case where the power-control assembly 102 receives the power-connect command signal.

The power-control assembly 102 is also configured to convey (transmit) a door-close signal indicating to close the refrigerator door 902 of the refrigerator 900 for the case where the power-control assembly 102 receives the power-connect command signal.

The actuator assembly 104 is further configured to electrically couple to the power-control assembly 102 in such a way as to receive the door-close signal from the power-control assembly 102 once the door-close signal is transmitted from the power-control assembly 102.

The actuator assembly 104 is further configured to mechanically operate the refrigerator door 902 for the case where the door-close signal is received from the power-control assembly 102 in such a way that the actuator assembly 104 closes the refrigerator door 902 shut in a door-closed state (as depicted in FIG. 2A).

The technical effect of the apparatus 100 (once the door-closed state is achieved) is improved service for the user of the hotel room, at least in part, since the refrigerator 900 is available for the enjoyment of the user of the hotel room once the apparatus 100 turns on the electrical power to the refrigerator 900 (for the case where the hotel room, for example, becomes occupied).

In accordance with an embodiment, the actuator assembly 104 is configured to be mounted to an exterior of the refrigerator 900 (as depicted in FIG. 2A and 2B, to the top section of the refrigerator 900).

In accordance with an embodiment, there is provided a method. The method is for operating the refrigerator 900 with the apparatus 100. The method includes an operation for configuring the power-control assembly 102, and an operation for configuring the actuator assembly 104 as described above.

It is believed that the person of skill in the art would be able to build and operate the apparatus 100 in view of the foregoing description.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a refrigerator having a refrigerator door, the refrigerator being configured to be electrically powered via an electrical power outlet, the apparatus comprising:
a power-control assembly being configured to:
electrically connect to the electrical power outlet in such a way that electrical power is received from the electrical power outlet to the power-control assembly;
electrically connect to an electrical cord of the refrigerator;
provide the electrical power received from the electrical power outlet to the refrigerator via the power-control assembly;
receive a power-disconnect command signal indicating that the electrical power is to be disconnected from the refrigerator for the case where the power-disconnect command signal is received by the power-control assembly;
disconnect the electrical power to the refrigerator for the case where the power-control assembly receives the power-disconnect command signal; and
convey a door-open signal indicating to open the refrigerator door of the refrigerator for the case where the power-control assembly receives the power-disconnect command signal; and
an actuator assembly being configured to:
electrically couple to the power-control assembly in such a way that the actuator assembly receives the door-open signal from the power-control assembly once the door-open signal is transmitted from the power-control assembly; and
mechanically operate the refrigerator door for the case where the door-open signal is received from the power-control assembly in such a way that the actuator assembly, in use, holds the refrigerator door, in use, ajar in a door-open state.

2. The apparatus of claim 1, wherein:
the power-control assembly is configured to:
receive a power-connect command signal indicating that the electrical power is to be connected to the refrigerator for the case where the power-connect command signal is received by the power-control assembly;
connect the electrical power to the refrigerator for the case where the power-control assembly receives the power-connect command signal; and
convey a door-close signal indicating to close the refrigerator door of the refrigerator for the case where the power-control assembly receives the power-connect command signal; and
the actuator assembly is further configured to:
electrically couple to the power-control assembly in such a way as to receive the door-close signal from the power-control assembly once the door-close signal is transmitted from the power-control assembly; and
mechanically operate the refrigerator door for the case where the door-close signal is received from the power-control assembly in such a way that the actuator assembly, in use, closes the refrigerator door shut in a door-closed state.

3. The apparatus of claim 1, wherein:
the actuator assembly is configured to be mounted to an exterior of the refrigerator.

4. A method of operating a refrigerator having a refrigerator door, the refrigerator being configured to be electrically powered via an electrical power outlet by using an apparatus including a power-control assembly and an actuator assembly, the method comprising:
configuring the power-control assembly to:
electrically connect to the electrical power outlet in such a way that electrical power is received from the electrical power outlet to the power-control assembly;
electrically connect to an electrical cord of the refrigerator;
provide the electrical power received from the electrical power outlet to the refrigerator via the power-control assembly;
receive a power-disconnect command signal indicating that the electrical power is to be disconnected from the refrigerator for the case where the power-disconnect command signal is received by the power-control assembly;
disconnect the electrical power to the refrigerator for the case where the power-control assembly receives the power-disconnect command signal; and
convey a door-open signal indicating to open the refrigerator door of the refrigerator for the case where the power-control assembly receives the power-disconnect command signal; and
configuring the actuator assembly to:
electrically couple to the power-control assembly in such a way that the actuator assembly receives the door-open signal from the power-control assembly once the door-open signal is transmitted from the power-control assembly; and
mechanically operate the refrigerator door for the case where the door-open signal is received from the power-control assembly in such a way that the actuator assembly, in use, holds the refrigerator door, in use, ajar in a door-open state.

5. The method of claim 4, further comprising:
receive a power-connect command signal indicating that the electrical power is to be connected to the refrigerator for the case where the power-connect command signal is received by the power-control assembly;
connect the electrical power to the refrigerator for the case where the power-control assembly receives the power-connect command signal; and
convey a door-close signal indicating to close the refrigerator door of the refrigerator for the case where the power-control assembly receives the power-connect command signal; and
the actuator assembly is further configured to:
electrically couple to the power-control assembly in such a way as to receive the door-close signal from the power-control assembly once the door-close signal is transmitted from the power-control assembly; and
mechanically operate the refrigerator door for the case where the door-close signal is received from the power-control assembly in such a way that the actuator assembly, in use, closes the refrigerator door shut in a door-closed state.
